(19) United States
(12) Patent Application Publication
(10) Pub. No.: US 2016/0154934 A1
(43) Pub. Date: Jun. 2, 2016

(54) RULES ENGINE REFERENCING FOR MEDICAL DATA

(71) Applicant: General Electric Company, Schenectady, NY (US)

(72) Inventors: Gordon Ian Rowlandson, Wauwatosa, WI (US); Michael Andrew Juhl, Wauwatosa, WI (US)

(73) Assignee: General Electric Company, Schenectady, NY (US)

(21) Appl. No.: 14/556,710

(22) Filed: Dec. 1, 2014

(51) Int. Cl. G06F 19/00

(52) U.S. Cl. CPC G06F 19/322; G06F 19/3487

(57) ABSTRACT

Techniques for rules engine referencing are described herein. The techniques may include receiving electrocardiograph (ECG) data for a subject and identifying an electronic medical record (EMR) associated with the subject. The techniques further including referencing a rules engine including multiple configurable conditions defining when specific ECG data is to be linked to the EMR, and linking the specific ECG data to the EMR if one or more of the plurality of configurable conditions are met.

### BACKGROUND OF THE INVENTION

The subject matter disclosed herein relates generally to techniques for linking medical data. In diagnostic medicine, measurements may be taken for a subject, such as a patient, using various instruments. For example, an electrocardiograph (ECG) instrument may be used to record electrical activity of a heart of a patient. Many hospitals also implement electronic medical records employing a systematic collection of electronic health information about an individual patient or population. However, in some cases, specific information of measured health data may not appear on a health record. Further, in some cases, specific information of measured health data may not be essential to appear on a health record.

### BRIEF DESCRIPTION OF THE INVENTION

An embodiment relates to a method for referencing a rules engine. The method may include receiving electrocardiograph (ECG) data for a subject, and identifying an electronic medical record (EMR) associated with the subject. The method includes referencing a rules engine having a plurality of configurable conditions defining when specific ECG data is to be linked to the EMR, and linking the specific ECG data to the EMR if one or more of the plurality of configurable conditions are met.

Another embodiment relates to a system for referencing a rules engine. The system may include a processing device and a rules module. The rules module may be configured to be stored on a storage device. The rules module may be executable by the processing device. When executed, the rules module may cause the system to receive ECG data for a subject, and identify an EMR associated with the subject. The rules module may also cause the system to reference a rules engine having a plurality of configurable conditions defining when specific ECG data is to be linked to the EMR. linking the specific ECG data to the EMR if one or more of the plurality of configurable conditions are met.

Still another embodiment relates to a computer-readable medium for referencing a rules engine. The computer-readable medium includes processor-executable code to receive ECG data for a subject, and identify an EMR associated with the subject. The computer-readable medium includes processor-executable code to reference a rules engine having a plurality of configurable conditions defining when specific ECG data is to be linked to the EMR and to link the specific ECG data to the EMR if one or more of the plurality of configurable conditions are met.

### BRIEF DESCRIPTION OF THE DRAWINGS

The present techniques will become more fully understood from the following detailed description, taken in conjunction with the accompanying drawings, wherein like reference numerals refer to like parts, in which:

FIG. 1 illustrates a block diagram illustrating a computing system configured to reference a rules engine;

FIG. 2 illustrates a graphical user interface to render an electronic medical record (EMR) having specific data highlighted based on a rules engine reference;

FIG. 3 is a flow diagram of a process of rules engine referencing;

FIG. 4 is a block diagram illustrating a method of rules engine referencing; and

FIG. 5 is a block diagram of a computer readable medium that includes modules for rules engine referencing.

### DETAILED DESCRIPTION OF THE INVENTION

In the following detailed description, reference is made to the accompanying drawings that form a part hereof, and in which is shown by way of illustration of specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the embodiments described herein.

As used herein, the terms “system,” “unit,” or “module” may include a hardware and/or software system that operates to perform one or more functions. For example, a module, unit, or system may include a computer processor, controller, or other logic-based device that performs operations based on instructions stored on a tangible and non-transitory computer readable storage medium, such as a computer memory. Alternatively, a module, unit, or system may include a hard-wired device that performs operations based on hard-wired logic of the device. Various modules or units shown in the attached figures may represent the hardware that operates based on software or hardwired instructions, the software that directs hardware to perform the operations, or a combination thereof.

Various embodiments provide techniques for rules engine referencing in a medical environment. As discussed above, an electronic medical record (EMR) may employ systematic collection of electronic health information. However, some information may not be needed on an EMR in some cases, while additional information may be useful in other cases. For example, a hospital administrator may desire to have certain data in an EMR flagged with additional information when an electrocardiograph (ECG) indicates a time interval between a start of a Q wave and the end of a T wave (QT interval) above a certain threshold. As another example, electrolyte levels acquired for a given patient may expire after a given time, and therefore, an administrator may desire to have this data flagged, or suppressed, in an EMR. The techniques described include receiving measured medical data in an electronic format, such as ECG data, for a subject, and identifying an EMR associated with the subject. Based on a reference to a rules engine, links between the ECG and the EMR may be identified. The EMR may be modified according to the reference to the rules engine wherein configurable conditions are defined indicating when specific ECG data is to be linked to the EMR.

It should be noted that although the various embodiments are described in connection with a particular diagnostic medical instrument, such as an ECG machine, the various embodiments may be implemented in connection with other medical instruments, such as an X-ray computed tomography (x-ray CT) detector system, a Positron Emission Tomography (PET) imaging system, and the like. Additionally, the diagnostic medical instrument may be used to capture data of different subjects, including subjects other than people.

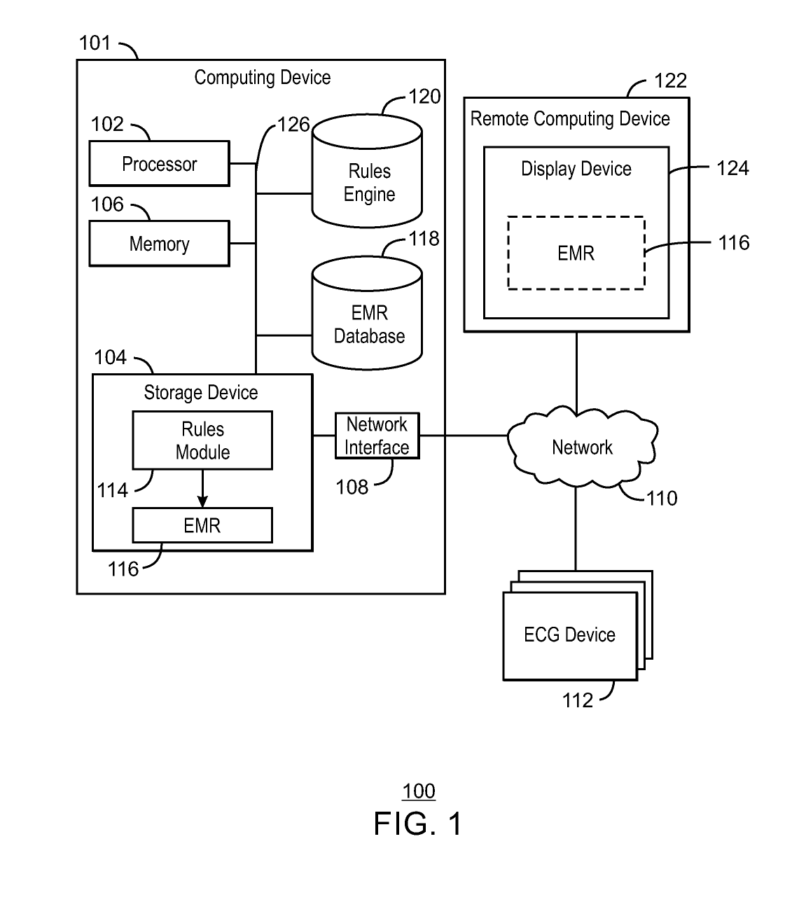

FIG. 1 illustrates a block diagram illustrating a computing system configured to reference a rules engine. The computing system 100 may include a computing device 101 having a processor 102, a storage device 104, a memory device 106, and a network interface 108. The computing device 101 may be a centralized computing device, such as server, in a medical environment, such as a hospital, a clinic, and the like. In this case, the computing device 101 may communicate, via the network interface 108, with a network 110 to receive data from one or more ECG devices 112.

The storage device 104 may be a non-transitory computer-readable medium having a rules module 114. The rules module 114 may be implemented as logic, at least partially comprising hardware logic, as firmware embedded into a larger computing system, or any combination thereof. The rules module 114 is configured to receive ECG data for a subject from the one or more ECG devices 112. The rules module 114 may be configured to identify an EMR 116 from among a plurality of EMRs stored in an EMR database 116. A rules engine 120 may be referenced by the rules module 114. The rules engine 120 may be disposed within the computing device 101 or communicatively coupled to the computing device 101 via the network 110. Similarly, the EMR database 118 may be stored locally on the computing device 101 or be communicatively available to the computing device 101 via the network 110. In any case, the rules engine 120 comprises multiple configurable conditions defining when specific ECG data is to be linked to the identified EMR 116.

In embodiments, the rules module 112 may be configured to modify the EMR 116 to be presented at a remote computing device 122 having a display device 124 via the network 110, as indicated by the dashed box 116. Modifications to the EMR 116 are based on various conditions defined in the rules engine. For example, a QT value above a certain threshold may be defined as abnormal by a condition in the rules engine 120. If this condition is enabled, the rules module 114 may highlight QT data in the EMR 116 rendered at the display device 124. In other words, the rules module 114 may be configured to link specific ECG data to the EMR 116 if one or more of a plurality of conditions are met.

It is important to note that although the system 100 illustrates computing devices 101 and 122, as being distributed, other configurations are possible and considered by the techniques described herein. For example, the computing device 101 may also include a display device, either integrated or peripheral to the computing device 101, to display the EMR 116 having modified information. In any case, the particular implementation will reference a rules engine to determine when specific ECG data is to be linked with a given EMR. Further examples of when specific ECG data is linked with a given EMR are described in more detail below.

The processor 102 may be a main processor that is adapted to execute the stored instructions. The processor 102 may be a single core processor, a multi-core processor, a computing cluster, or any number of other configurations. The processor 102 may be implemented as Complex Instruction Set Computer (CISC) or Reduced Instruction Set Computer (RISC) processors, x86 Instruction set compatible processors, multi-core, or any other microprocessor or central processing unit (CPU).

The memory device 106 can include random access memory (RAM) (e.g., static RAM, dynamic RAM, zero capacitor RAM, Silicon-Oxide-Nitride-Oxide-Silicon, embedded dynamic RAM, extended data out RAM, double data rate RAM, resistive RAM, parameter RAM, etc.), read only memory (ROM) (e.g., Mask ROM, parameter ROM, erasable programmable ROM, electrically erasable programmable ROM, etc.), flash memory, or any other suitable memory systems. The main processor 102 may be connected through a system bus 126 (e.g., PCI, ISA, PCI-Express, etc.) to the network interface 108. The network interface 108 may enable the computing device 101 to communicate, via the network 112, with the ECG devices 112 and the remote computing device 122.

In embodiments, the remote computing device 122 may render images at the display device 124. The display device 108 may an integrated component of the remote computing device 122, a remote component such as an external monitor, or any other configuration enabling the remote computing device 122 to render a graphical user interface. As discussed above, and in more detail below, a graphical user interface rendered at the display device 124 may be used to render the EMR 116 based on a reference to the rules engine 120.

The block diagram of FIG. 1 is not intended to indicate that the computing device 101 is to include all of the components shown in FIG. 1. Further, the computing device 101 may include any number of additional components not shown in FIG. 1, depending on the details of the specific implementation.

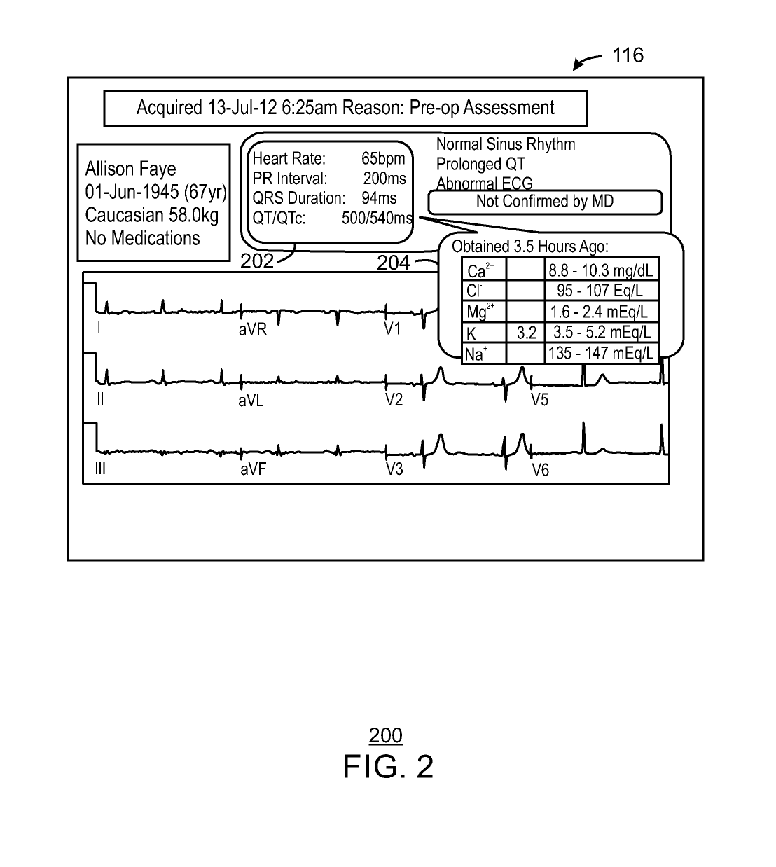

FIG. 2 illustrates a graphical user interface to render an EMR having specific data highlighted based on a rules engine reference. As discussed above, a rules engine, such as the rules engine 120, may define a QT period, as well as a corrected QT (QTc) period above a predetermined threshold to be associated with a health risk. Therefore, as indicated in FIG. 2, QT/QTc data above the predetermined threshold may be highlighted in a graphical user interface 200, as indicated at 202. The graphical user interface 200 may be configured to render an EMR, such as the EMR 116, in a display device, such as a display device 124 of the remote computing device 122 of FIG. 1.

Further, the rules engine 120 may define that when this particular condition is selected by a user, additional information may be displayed including how long ago the ECG data was measured, electrolyte levels measured, and the like, as indicated at 204. By providing specific ECG data based on a rules engine reference to the EMR 116, relevant data may be presented to a viewer of the EMR 116. For example, if the abnormal QT/QTc value 202 was acquired past a certain time period threshold, then the abnormal QT/QTc value 202 may not be relevant. Therefore, although not shown in the additional information displayed at 204, a user may be provided information indicating that the time period of 3.5 hours is or is not relevant.

Other conditions are considered. Examples of various conditions may be illustrated by Tables 1A and 1B below:

TABLE 1A

| | | | Enable | Access | |
|---|---|---|---|---|---|
| | Rule Title | Generic Logic Applied | Rule | Rights | ECG Inputs |
| 1 | Long QT/QTc - | When user points to | Yes/No | All Users | Current ECG |
| | Simple Help | highlighted value, an | | | |
| | | advisory message | | | |
| | | appears | | | |
| 2 | Long QT/QTc - | When user points to | Yes/No | All Users | Current ECG |
| | Simple Help with | highlighted value, an | | | |
| | Superimposed | advisory message | | | |
| | Waveforms | appears | | | |
| 3 | Long QT/QTc - | When user points to | Yes/No | Physician | Current ECG |
| | Portal to | highlighted value, help | | class level | |
| | Electrolytes | message appears along | | I | |
| | | with supplemental | | | |
| | | information | | | |
| 4 | Long QT/QTc - | When user points to | Yes/No | Physician | Current ECG |
| | Portal to | highlighted value, help | | class level | |
| | Electrolytes and | message appears along | | II | |
| | Drug interactions | with supplemental | | | |
| | | information | | | |
| 5 | Afib | When user points to | Yes/No | All Users | Current ECG, |
| | | highlighted value, an | | | Confirmed |
| | | advisory message | | | |
| | | appears | | | |
| 6 | Afib - CHADs | When user points to | Yes/No | Physician | Current ECG, |
| | Score | highlighted value, help | | level III | Confirmed |
| | | message appears along | | | |
| | | with supplemental | | | |
| | | information | | | |

In Table 1A, six example conditions/rules are illustrated. Table 1B below is a continuation of details associated with each condition.

TABLE 1B

| | Required | | | | | | |
|---|---|---|---|---|---|---|---|
| | HL7 Inputs | Highlighted | | | | | |
| | From EMR | Critical | | | | | |
| | with | Value | | | | | |
| | Criterion for | and | | | Supplemental | Supplemental | Supplemental |
| | Timeliness | Rule | Action | Help Message | Waveform | Table | Table |
| 1 | None | QT/QTc | Display | A QT/QTc of this | | | |
| | | >460 ms | help | length is | | | |
| | | | message | considered of high | | | |
| | | | | risk. See | | | |
| | | | | following Web | | | |
| | | | | Site for specific | | | |
| | | | | drugs and guidance | | | |
| | | | | on actions | | | |
| 2 | None | QT/QTc | Display | A QT/QTc of this | Superimposed | | |
| | | >460 ms | help | length is | beats | | |
| | | | message | considered of high | with tic | | |
| | | | and | risk. See | marks | | |
| | | | supplemental | following Web | | | |
| | | | waveform | Site for specific | | | |
| | | | | drugs and guidance | | | |
| | | | | on actions | | | |
| 3 | Potassium | QT/QTc | Display | A QT/QTc of this | Superimposed | Electrolytes | |
| | (24 hours), | >460 ms | help | length is | beats | | |
| | Calcium (12 | | message, | considered of high | with tic | | |
| | hours), | | supplemental | risk. See | marks | | |
| | Sodium (6 | | waveform | following Web | | | |
| | hours) | | and | Site for specific | | | |
| | | | table | drugs and guidance | | | |
| | | | | on actions | | | |
| 4 | Potassium | QT/QTc | Display | A QT/QTc of this | Superimposed | Electrolytes | Drugs |
| | (24 hours), | >460 ms | help | length is | beats | | known |
| | Calcium (12 | | message, | considered of high | with tic | | to |
| | hours), | | supplemental | risk. See patient | marks | | prolong |
| | Sodium (6 | | waveform | information related | | | QT |
| | hours), | | and | to this risk. | | | |
| | Drugs | | table | | | | |
| 5 | | Afib is | Display | Afib is correlated | | | |
| | | Present | help | with stroke. | | | |
| | | | message | Considerable | | | |
| | | | | follow up | | | |
| 6 | Values | Afib is | Display | Patient does not | | CHADS | |
| | related to | Present | help | appear to be on | | score | |
| | CHADS | and Not | message | anti-coagulants. | | | |
| | | on Anti- | and | CHADS score >2 | | | |
| | | Coagulants | supplemental | is considered high | | | |
| | | | table | risk | | | |

As illustrated in Table 1A and continuing on Table 1B, a plurality of conditions may be implemented by the rules engine to display information that is relevant to a viewer of the EMR 116. For example, if a viewer clicks on the abnormal QT/QTc value 202, additional operations may be performed beyond the display of additional information 204. These additional operations may include, for example, a more detailed view of an ECG waveform than a wave form 206 illustrated in FIG. 2, lists of drugs known to prolong a QT period that the patient is currently taking as indicated in the EMR, a list of electrolyte values highlighting those that are outside normal limits, and the like. Rules may be applied for other types of ECG data such as atrial fibrillation (AFIB), an aggregate metric, and the like, as indicated in Tables 1A and 1B. An example of an aggregate metric may include a CHADS score wherein congestive heart failure, hypertension, age, diabetes mellitus, prior stroke or thromboembolism, are used in aggregate to estimate risk of a medical condition such as a stroke in a patient.

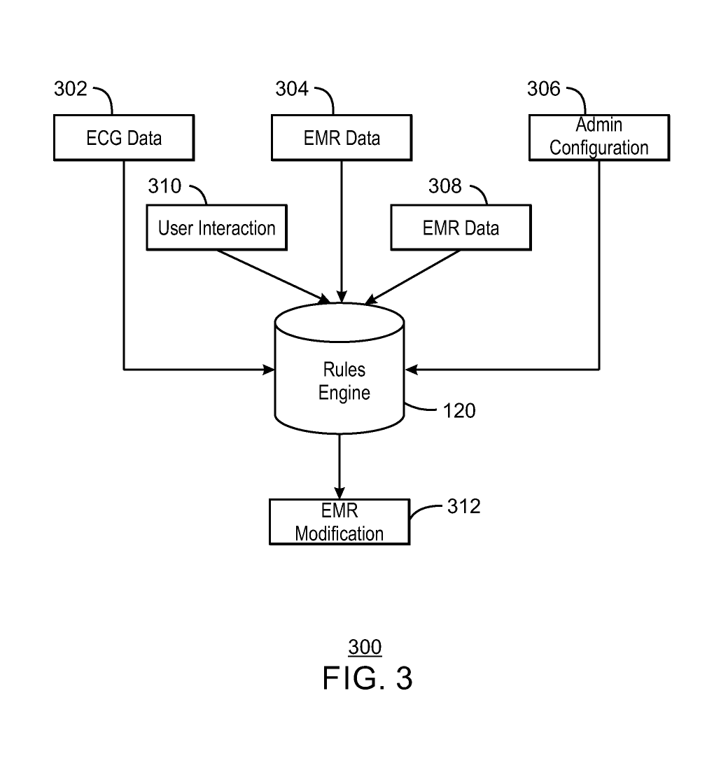

FIG. 3 is a flow diagram of a process of rules engine referencing. As illustrated in FIG. 3, inputs to a rules engine, such as the rules engine 120 of FIG. 1, may include ECG data 302, EMR data 304, an administrator's configuration 306, and EMR data 308. Further, in some cases, a user's interaction with the data may be used to dynamically change what is presented in the EMR. Based on these various inputs, the rules engine 120 outputs an EMR modification 312.

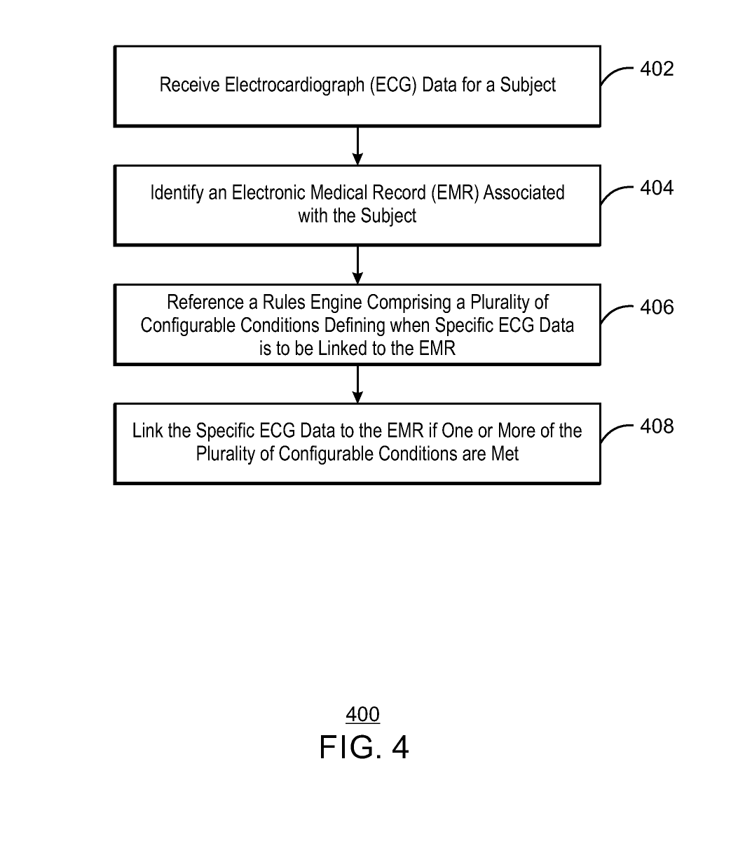

FIG. 4 is a block diagram illustrating a method of rules engine referencing. The method begins at 402 wherein ECG data is received for a subject. At block 404, an EMR is identified that is associated with the subject. At block 406, a rules engine is referenced. The rules engine includes multiple configurable conditions defining when specific ECG data is to be linked to the EMR. At block 408, specific ECG data may be linked to the EMR if one or more of the multiple configurable conditions are met.

The method 400 may include additional steps not illustrated in FIG. 4. For example, the method 400 may include performing one or more operations based on an existence of a link between the specific ECG data and the EMR. For example, one of the one or more operations includes providing an indication of the specific ECG data to the EMR based on the link between the specific ECG data and the EMR. Providing an indication of specific ECG data in the EMR may include highlighting the specific ECG data in the EMR and providing a message when a user selects the highlighted data. In some cases, the message includes an advisory message related to the specific ECG data, a help message related to the specific ECG data, or any combination thereof.

The method 400 may also include defining a link between ECG data and the EMR based on contextual data related to the capture of the ECG data for the subject, based on contextual data related to a medical condition of the subject, or any combination thereof. For example, the contextual data may include whether or the not subject is being measured before or after a medical operation, whether the subject is on any medication affecting an ECG measurement result, what area of a hospital the patient is in, how recent the ECG data is, and the like.

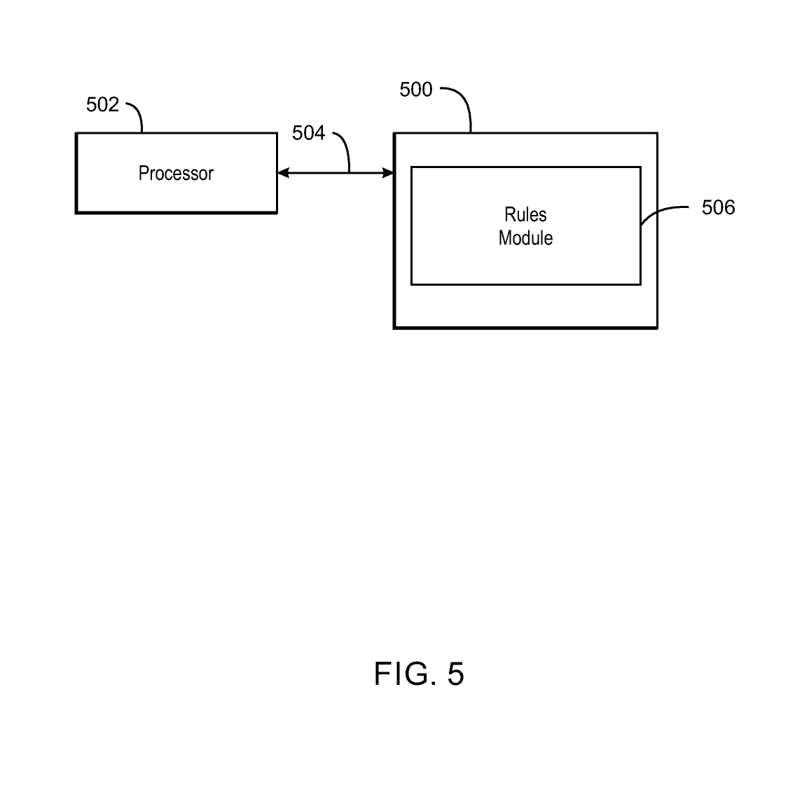

FIG. 5 is a block diagram of a computer readable medium that includes modules for rules engine referencing. The computer readable medium 500 may be a non-transitory computer readable medium, a storage device configured to store executable instructions, or any combination thereof. In any case, the computer-readable medium is not configured as a carry wave or a signal.

The computer-readable medium 500 includes code adapted to direct a processor 502 to perform actions. The processor 502 accesses the modules over a system bus 504. A rules module 506 may be configured to receive electrocardiograph (ECG) data for a subject and identify an electronic medical record (EMR) associated with the subject. The rules module 506 may also be configured to reference a rules engine comprising a plurality of configurable conditions defining when specific ECG data is to be linked to the EMR, and link the specific ECG data to the EMR if one or more of the plurality of configurable conditions are met.

While the detailed drawings and specific examples given describe particular embodiments, they serve the purpose of illustration only. The systems and methods shown and described are not limited to the precise details and conditions provided herein. Rather, any number of substitutions, modifications, changes, and/or omissions may be made in the design, operating conditions, and arrangements of the embodiments described herein without departing from the spirit of the present techniques as expressed in the appended claims.

This written description uses examples to disclose the techniques described herein, including the best mode, and also to enable any person skilled in the art to practice the techniques described herein, including making and using any devices or systems and performing any incorporated methods. The patentable scope of the techniques described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for rules engine referencing, comprising:
receiving electrocardiograph (ECG) data for a subject;
identifying an electronic medical record (EMR) associated with the subject;
referencing a rules engine comprising a plurality of configurable conditions defining when specific ECG data is to be linked to the EMR; and
linking the specific ECG data to the EMR if one or more of the plurality of configurable conditions are met.

2. The method of claim 1, further comprising performing one or more operations based on the link between the specific ECG data and the EMR.

3. The method of claim 2, wherein the one or more operations comprise providing an indication of the specific ECG data to the EMR based on the link between the specific EGC data and the EMR.

4. The method of claim 3, wherein providing the indication of specific ECG data comprises:
highlighting the specific ECG data in the EMR; and
providing a message when a user selects the highlighted data.

5. The method of claim 4, wherein the message comprises:
an advisory message related to the specific ECG data;
a help message related to the specific ECG data; or
any combination thereof.

6. The method of claim 1, further comprising defining the link between ECG data and the EMR based on contextual data related to the capture of the ECG data for the subject.

7. The method of claim 1, further comprising defining the link between ECG data and the EMR based on contextual data related to a medical condition of the subject.

8. A system for rules engine referencing, comprising:
a processing device;
a rules module stored on a storage device that, when executed by the processing device, cause the system to:
receive electrocardiograph (ECG) data for a subject;
identify an electronic medical record (EMR) associated with the subject;
reference a rules engine comprising a plurality of configurable conditions defining when specific ECG data is to be linked to the EMR; and
link the specific ECG data to the EMR if one or more of the plurality of configurable conditions are met.

9. The system of claim 8, wherein the rules engine, when executed by the processing device, is further configured to perform one or more operations based on the link between the specific ECG data and the EMR.

10. The system of claim 9, wherein the one or more operations comprise providing an indication of the specific ECG data to the EMR based on the link between the specific EGC data and the EMR.

11. The system of claim 10, wherein providing the indication of specific ECG data comprises:
highlighting the specific ECG data in the EMR; and
providing a message when a user selects the highlighted data.

12. The system of claim 11, wherein the message comprises:
an advisory message related to the specific ECG data;
a help message related to the specific ECG data; or
any combination thereof.

13. The system of claim 8, wherein the rules engine, when executed by the processing device, is further configured to define the link between ECG data and the EMR based on contextual data related to the capture of the ECG data for the subject.

14. The system of claim 8, wherein the rules engine, when executed by the processing device, is further configured to define the link between ECG data and the EMR based on contextual data related to a medical condition of the subject.

15. A computer-readable medium for rules engine referencing, the computer-readable medium comprising processor-executable code to:
receive electrocardiograph (ECG) data for a subject;
identify an electronic medical record (EMR) associated with the subject;
reference a rules engine comprising a plurality of configurable conditions defining when specific ECG data is to be linked to the EMR; and
linking the specific ECG data to the EMR if one or more of the plurality of configurable conditions are met.

16. The computer-readable medium of claim 15, wherein the rules engine, when executed by the processing device, is further configured to perform one or more operations based on the link between the specific ECG data and the EMR.

17. The computer-readable medium of claim 16, wherein the one or more operations comprise providing an indication of the specific ECG data to the EMR based on the link between the specific EGC data and the EMR.

18. The computer-readable medium of claim 17, wherein providing the indication of specific ECG data comprises:
highlighting the specific ECG data in the EMR; and
providing a message when a user selects the highlighted data.

19. The computer-readable medium of claim 15, wherein the rules engine, when executed by the processing device, is further configured to define the link between ECG data and the EMR based on contextual data related to the capture of the ECG data for the subject.

20. The computer-readable medium of claim 15, wherein the rules engine, when executed by the processing device, is further configured to define the link between ECG data and the EMR based on contextual data related to a medical condition of the subject.
